(19) United States
(12) Patent Application Publication
(10) Pub. No.: US 2007/0275137 A1
(43) Pub. Date: Nov. 29, 2007

(54) Food-processing component and method of coating thereof

(75) Inventors: Benjamin G. Hardy, Elkhorn, WI (US); Drew J. Van Norman, Whitewater, WI (US); Gary Ferguson, Milton, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/440,060

(22) Filed: May 25, 2006

(51) Int. Cl. A23L 1/00; A23F 5/00

(52) U.S. Cl. 426/302

(57) ABSTRACT

A method of coating a food-processing component. The method includes submerging a first portion of a food-processing component in a plating solution that includes particles. The method also includes forming a coating on the first portion of the food-processing component submerged in the plating solution, wherein the coating includes a matrix and the particles included in the matrix. Also, a food-processing component and a coater configured to form a coating on a food-processing component.

### FIELD OF THE INVENTION

The present invention relates generally to food-processing components such as, for example, a food pump. In addition, the present invention also relates to methods and systems for coating food-processing components.

### BACKGROUND OF THE INVENTION

Pumps such as, for example, circumferential piston pumps, are currently being used in the food and beverage industry to process a variety of liquids and semi-solid foodstuffs. Currently, these pumps are positive displacement pumps and include rotors made from a nickel/bismuth alloy.

The nickel/bismuth alloy is chosen because, unlike many other materials, it does not gall when it comes into contact with stainless steel components during operation of the pump. This resistance to galling is particularly desirable in many food and beverage applications because tight rotor clearances are often required in order to improve the efficiency of the pump.

Unfortunately, this nickel/bismuth alloy is relatively expensive. Also, this alloy is relatively soft and is susceptible to failure due to impingement wear, which exists in many industrial applications, particularly those that involve liquids with small, hard particulates floating or suspended therein (e.g., some foodstuffs, automotive paint and paper coatings).

Accordingly, it would be desirable to provide a gall-resistant material that is also relatively hard. Such a material could be utilized, for example, in pumps used in the food and beverage industry.

### SUMMARY OF THE INVENTION

The foregoing needs are met, to a great extent, by certain embodiments of the present invention. According to one embodiment of the present invention, a method of coating a food-processing component is provided. The method includes submerging a first portion of a food-processing component in a plating solution that includes particles. The method also includes forming a coating on the first portion of the food-processing component submerged in the plating solution, wherein the coating includes a matrix and the particles included in the matrix.

In accordance with another embodiment of the present invention, a food-processing component is provided. The food-processing component includes a first portion of a food-processing component and a coating formed on the first portion of the food-processing component. The coating is formed by submerging the first portion of the food-processing component in a plating solution that includes particles and forming the coating on the first portion of the food-processing component submerged in the plating solution, wherein the coating includes a matrix and the particles included in the matrix.

In accordance with yet another embodiment of the present invention, a coater configured to form a coating on a food-processing component is provided. The coater includes means for submerging a first portion of a food-processing component in a plating solution that includes particles. The coater also includes means for forming a coating on the first portion of the food-processing component submerged in the plating solution, wherein the coating includes a matrix and the particles included in the matrix.

In accordance with still another embodiment of the present invention, another pump component is provided. This pump component includes a first portion of a pump component. This pump component also includes a coating formed on the first portion of the pump component, wherein the coating includes a matrix and particles included in the matrix, and wherein the first portion of the pump component is not visible from any position outside of the food-processing component.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a cross-section of a food-processing component according to an embodiment of the present invention.

FIG. 2 is a flowchart illustrating the steps of a method of coating a food-processing component according to an embodiment of the present invention.

### DETAILED DESCRIPTION

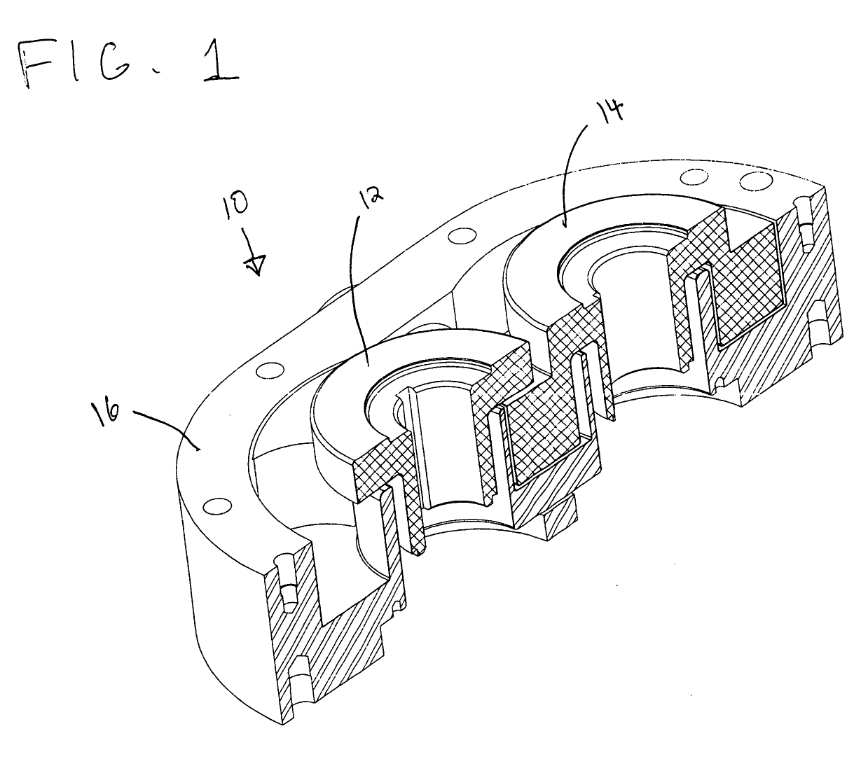

The invention will now be described with reference to the drawing figures, in which like reference numerals refer to like parts throughout. FIG. 1 illustrates a perspective view of a representative cross-section of a food-processing component 10 according to an embodiment of the invention. The food-processing component 10 is a food pump that includes two rotors 12, 14 and a body 16. However, other types of food-processing components are also within the scope of the present invention.

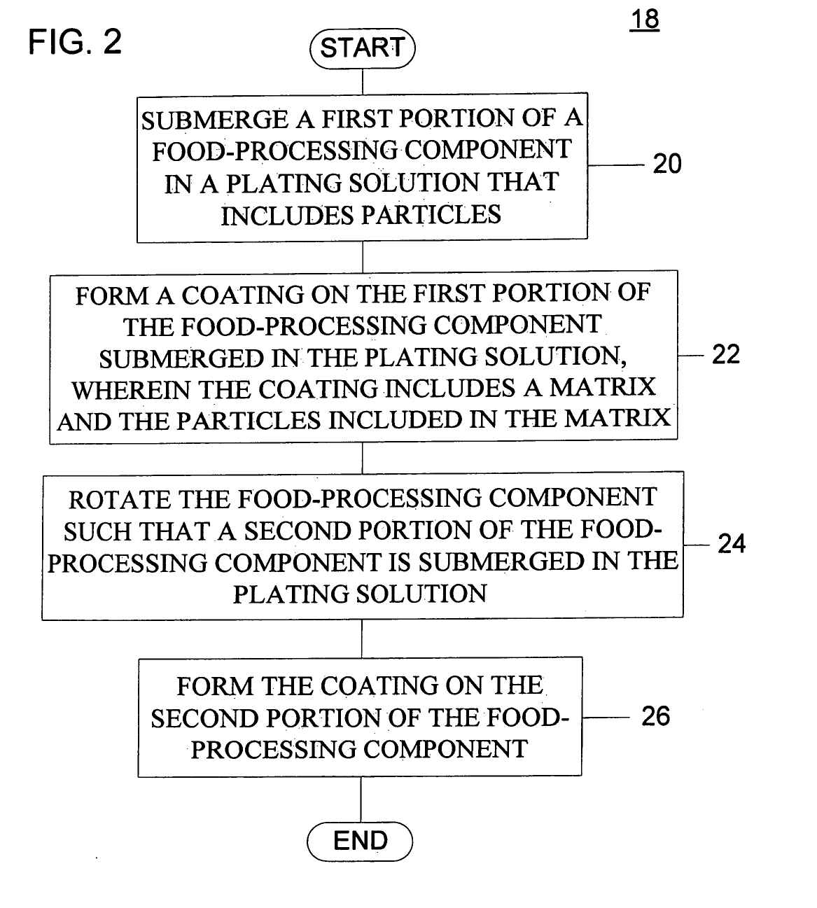

According to certain embodiments of the present invention, a method of coating a food-processing component (e.g., the food-processing component 10 illustrated in FIG. 1) is provided. FIG. 2 is a flowchart 18 illustrating the steps of this method according to an embodiment of the present invention.

The method includes, as illustrated in step 20 of the flowchart 18, submerging a first portion of a food-processing component (e.g., portions of one or more of the rotors 12, 14 and/or the body 16 illustrated in FIG. 1) in a plating solution that includes particles (e.g., hard particles such as diamond particles). The method also includes, as illustrated in step 22 of the flowchart 18, forming a coating on the first portion of the food-processing component submerged in the plating solution, wherein the coating includes a matrix and the particles included in the matrix. Examples of implementations of this formation step are included below.

According to certain embodiment of the present invention, in order to form the above-mentioned coating, particles of one or more materials are codeposited on a surface of a food-processing component (i.e., a substrate) with an electroless metal or alloy-plated matrix. According to other embodiments of the present invention, particles of one or more materials are plated with or otherwise encapsulated in a metal, an alloy (e.g., a nickel-based, cobalt-based, or iron-based alloy), an intermetallic phase, an intermediate phase, a plastic, and/or a ceramic. These encapsulated particles are then applied to a substrate via a process such as, but not limited to, electrical charge, magnetism, centrifugal force, and gravity.

Once the particles have been applied to the substrate, the encapsulated particles are then treated to create a composite that includes a matrix formed from the encapsulating material. Pursuant to this treatment, the particles are included and/or dispersed within the matrix.

According to one embodiment of the present invention, the treatment used includes plating micron-scaled or nanometer-scaled diamond particles with a very thin film of a metal (e.g., copper, silver, gold, nickel) or metal alloy. The treatment also includes applying the plated particles onto a substrate and heating the substrate and plated particles to a temperature sufficient to at least partially melt the metal or alloy on the particles. This heating effectively fuses the plated particles together to form a composite that includes a high density of particles within a metal or metal alloy matrix. This heating step also effectively hardens the coating.

According to one embodiment of the present invention, a 25-micron-thick layer of composite electroless nickel with 4 micron diamond is plated on the food-processing component using the above-described steps and the plating bath commercially known as NiPLATE.RTM.800 of Surface Technology, Inc., Trenton, N.J.

According to certain embodiments of the present invention, particles other than diamond particles, which typically have a Mohs hardness of 10, are used. For example, alternate particles having Mohs hardnesses of greater than approximately 7, 8 or 9 are also within the scope of certain embodiments of the present invention.

Diamond particles according to certain embodiments of the present invention include particles that substantially possess the hardness of the diamond molecular structure without necessarily possessing the ideal molecular structure. Also, diamond particles according to the present invention may include powders, flakes, and the like.

According to certain embodiments of the present invention, the particles have an average diameter of between about 5 and about 10 microns and are dispersed in a nickel-based alloy matrix. According to some of these embodiments, the average spacing between the particles is about 10 microns. However, coatings where particles are more widely or closely spaced relative to each other are also within the scope of the present invention.

According to other embodiments of the present invention, coatings are formed using electroless and/or electroplating processes. Such processes allow for food-processing components that have geometries wherein not all surfaces thereof are visible (i.e., wherein some surfaces are not within the line of sight of a person standing outside of the component) to be coated. Typically, the coatings have thicknesses in the range of between about 25 and 250 microns. However, coatings with higher or lower thicknesses are also within the scope of certain embodiments of the present invention.

According to certain embodiments of the present invention, the electroless plating process used includes immersing the food-processing component in a chemical aqueous salt plating bath using commercially-available compositions. This results in the deposition of an alloy (e.g., a nickel-boron alloy or a nickel-phosphorus alloy) onto the surface of the component when the component is dipped into the bath at an appropriate temperature (e.g., between about 80° C. and about 95° C.).

The particles are, according to certain embodiments of the present invention, kept dispersed and/or suspended in the bath solution by maintaining moderate agitation of the bath to prevent settling of the particles. According to one electroless plating process that is within the scope of the present invention, a nickel-plating bath includes 6 volume percent nickel sulfate solution, 15 volume percent sodium hypophosphite solution, and 79 volume percent deionized water is used to form a coating. In this process, the nickel concentration of the bath is maintained between about 5.5 and about 6.3 grams per liter during the coating process. The bath is also heated to about 87° C. and particles of a predetermined size and composition are dispersed in the bath.

According to this process, the component to be coated is typically attached to a rotating racking system. Then, as mentioned in step 24 of the flowchart 18, the component is submerged, either fully or partially, into the bath, and is rotated at an appropriate speed (e.g., between about 0.5 and about 2 revolutions per minute). As the component is rotated, various portions of the component are submerged in the plating solution. Each of these portions, as illustrated in step 26 of the flowchart 18, while submerged, has the coating formed thereon and the coating gradually thickens as the portion is repeatedly submerged.

In order to maintain the composition of the bath, the bath is periodically replenished. When the bath includes nickel, this replenishment may, for example, include adding a 0.6 volume percent solution of nickel sulfate and/or a 0.6 volume percent pH modifier.

Typically, the above-discussed electroless plating process is continued until a coating of a desired thickness has been formed on the component. According to certain embodiments of the present invention, once the desired thickness has either been reached or has almost been reached, replenishment of the bath ceases and the component is removed from the bath and dried. The component is then, according to certain embodiments of the present invention, heat treated. For example, the component may be heated in an oven for between about 1 and 2 hours at between about 300 and 350° C.

As mentioned above, electroplating processes are also within the scope of certain embodiments of the present invention. According to some such processes, hard particles (e.g., diamond nano-particles) are dispersed into a commercially-available plating bath solution that contains metal ions (e.g., a solution of metal sulfate solution in deionized water). The component is then either partially or fully submerged into the bath and rotated. Then, the component is fixed as a cathode and current is passed through the bath. This causes plating and the formation of a hard particle coating.

It should be noted that, when the component is of a geometry or fragility that prevents the component from being rotated in the above-discussed baths, the baths may be agitated through the motion of paddles or pumps to re-circulate the bath onto and into all of the surfaces desired to be coated (e.g., all surfaces that are submerged in the bath).

According to certain embodiments of the present invention, once the coating has been formed, the particles are substantially uniformly spaced in the coating. According to certain embodiments, the average spacing between adjacent hard particles is of less than about 5 or 10 micrometers. According to some of these embodiments, the nominal diameters of the hard particles are between about 0.25 microns and about 12 microns. The volume fraction of particles in the coating is typically greater than either about 25 percent or about 35 percent, wherein the volume fraction is based on the total volume of the composite coating.

According to certain embodiments of the present invention, the particles are coated with a stabilizing layer that prevents graphitizing, stabilizes the sp³ bonding of the particles (particularly when diamond particles are used), and/or facilitates a better bond of the hard particles with the metal or metal alloy that forms the matrix. Typically, the particles are coated prior to their addition to the above-discussed baths. Nickel, chromium, and/or titanium compounds are typically used to stabilize the particles, but other stabilizers may also be used.

In addition to or instead of the above-discussed diamond particles, other hard particles may be included in the above-discussed coatings. For example, SiC, B₄C, TiN, TiB₂, Si₃N₄, and/or Al₂O₃, may be included.

The above-discussed matrix may also include additives other than the hard particles discussed above. For example, phosphorus or boron may be included in a nickel-based alloy. Then, when heat-treated, the additions of P or B can form nano-sized precipitates that further strengthen the matrix. Also, nanoparticles of carbides, nitrides, borides, oxides, carbonitrides, oxynitrides or the like can be added for improved hardness and/or wear resistance properties. The nanoparticle may include, for example, one or more metals selected from Al, Si, W, Cr, Ti, Nb, Zr, Hf, Ta, and Mo. Moreover, the nanoparticles may be selected to reinforce the binder matrix through dislocation disruption. Exemplary nanoparticles used for this purposed include hard oxides such as alumina, carbides such as titanium carbide, borides such as titanium diboride, nitrides such as chromium nitride, and like nanoparticles.

As mentioned above, coatings according to the present invention may be used to prevent galling in food pumps. Provided below are Tables 1 and 2, which show the results of four experiments where, in each experiment, a different type of gall pin is placed into contact with the same type of rotating disk base (i.e., a rotating disk base made of stainless steel and being coated with a coating according to an embodiment of the present invention). As indicated in Table 1, the gall pin in test #1 is made of stainless steel, the gall pin in test #2 is made of stainless steel and has a coating according an embodiment of the present invention thereon, and the gall pin in test #3 is made of Waukesha Metal 88 (WM88), a commercially-available nickel alloy.

As indicated in Tables 1 and 2, the gall pin in test #2 was resistant to galling and therefore maintained its initial pin weight. In fact, based on the experiments whose results are shown below, it was determined that certain coatings according to the present invention have a resistance to galling against stainless steel that is at least equal to that of WM88.

TABLE 1

| | | | | | | Initial | Final |
|---|---|---|---|---|---|---|---|
| | | Disk | Plate | | Gall Pin | Pin | Pin |
| | | Base | Ra | Gall | Base | Weight | Weight |
| Test | Disk | Material | (ave.) | Pin | Material | (oz.) | (oz.) |
| 1 | Alpha | 316 w/ | 72 | Alpha | 316 | 1.955 | 1.901 |
| | | .005 | | | Stainless | | |
| | | CDC-8 | | | Steel | | |
| 2 | Beta | 316 w/ | 67 | 2 | 316 w/ | 1.991 | 1.991 |
| | | .005 | | | .004 | | |
| | | CDC-8 | | | CDC-8 | | |
| 3 | Gamma | 316 w/ | 67 | A | WM88 | 2.001 | 1.949 |
| | | .005 | | | | | |
| | | CDC-8 | | | | | |

TABLE 2

| Test | Material Loss | % Loss | Comments |
|---|---|---|---|
| 1 | 0.054 | 2.8% | Harsh grinding sound at start-up, but no |
| | | | galling. Harsh grinding sound |
| | | | throughout test, slight galling sighted at |
| | | | conclusion. |
| 2 | 0 | 0.0% | Virtually no sound at start-up. Ended |
| | | | very quiet, with no galling. |
| 3 | 0.052 | 2.6% | Low noise at start. Ended with squeaky |
| | | | noise but no galling seen. |

It should also be noted that coatings according to the present invention can be manufactured to comply with Food and Drug Administration (FDA) requirements for food contact. Further, some coatings according to the present invention also provide corrosion resistance to the components that they are placed on.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of coating a food-processing component, the method comprising:
submerging a first portion of a food-processing component in a plating solution that includes particles; and
forming a coating on the first portion of the food-processing component submerged in the plating solution, wherein the coating includes a matrix and the particles included in the matrix.

2. The method of claim 1, further comprising:
rotating the food-processing component such that a second portion of the food-processing component is submerged in the plating solution; and
forming the coating on the second portion of the food-processing component.

3. The method of claim 1, wherein the forming step comprises:
heating the first portion of the food-processing component to harden the coating thereon.

4. The method of claim 1, wherein the food-processing component includes a food pump.

5. The method of claim 1, wherein the food-processing component includes a rotor of a food pump.

6. The method of claim 1, wherein the submerging step comprises selecting diamond particles as the particles.

7. The method of claim 6, wherein the submerging step comprises selecting nanometer-scale diamond particles as the particles.

8. The method of claim 1, wherein the forming the coating step comprises including nickel in the matrix.

9. The method of claim 8, wherein the forming the coating step comprises including phosphorus in the matrix.

10. The method of claim 1, wherein the forming step comprises forming the coating to be resistant to galling.

11. The method of claim 10, wherein the forming step comprises forming the coating to have a resistance to galling against stainless steel at least equal to that of Waukesha Metal 88 (WM88).

12. The method of claim 1, wherein the forming step comprises forming the coating to comply with Food and Drug Administration (FDA) requirements for food contact.

13. The method of claim 1, wherein the forming step comprises forming the coating to be resistant to corrosion.

14. The method of claim 1, wherein the first portion of the food-processing component is not visible from any position outside of the food-processing component.

15. The method of claim 1, wherein the forming step comprises at least one of electroless and electroplating deposition.

16. A food-processing component, comprising:
a first portion of a food-processing component; and
a coating formed on the first portion of the food-processing component by
submerging the first portion of the food-processing component in a plating solution that includes particles; and
forming the coating on the first portion of the food-processing component submerged in the plating solution, wherein the coating includes a matrix and the particles included in the matrix.

17. The food-processing component of claim 16, wherein the coating is further formed by
rotating the food-processing component such that a second portion of the food-processing component is submerged in the plating solution; and
forming the coating on the second portion of the food-processing component.

18. The food-processing component of claim 16, wherein the food-processing component includes a rotor of a food pump.

19. A coater configured to form a coating on a food-processing component, the coater comprising:
means for submerging a first portion of a food-processing component in a plating solution that includes particles; and
means for forming a coating on the first portion of the food-processing component submerged in the plating solution, wherein the coating includes a matrix and the particles included in the matrix.

20. The coater of claim 19, further comprising:
means for rotating the food-processing component such that a second portion of the food-processing component is submerged in the plating solution; and
means for forming the coating on the second portion of the food-processing component.

21. A pump component, comprising:
a first portion of a pump component; and
a coating formed on the first portion of the pump component, wherein the coating includes a matrix and particles included in the matrix, and wherein the first portion of the pump component is not visible from any position outside of the food-processing component.

22. The pump component of claim 21, wherein the pump component includes a rotor of a food pump.
